(19) United States
(12) Patent Application Publication
(10) Pub. No.: US 2006/0111233 A1
(43) Pub. Date: May 25, 2006

(54) Removal of nitrogen and sulfur contamination from catalysts by hot hydrogen stripping

(75) Inventors: Xin Xiao, Houston, TX (US); Brandi Gomez, Houston, TX (US); Charles A. Comeaux, Houston, TX (US); Becky Fussell, Pasadena, TX (US)

Correspondence Address: FINA TECHNOLOGY INC, PO BOX 674412, HOUSTON, TX, 77267-4412, US

(73) Assignee: Fina Technology, Inc.

(21) Appl. No.: 10/993,328

(22) Filed: Nov. 19, 2004

(51) Int. Cl. B01J 38/10

(52) U.S. Cl. 502/53

(57) ABSTRACT

Nitrogen and optionally sulfur contamination can be removed from catalysts, such as spent and regenerated catalysts, by stripping them with a hydrogen-containing stream at high temperatures, such as between about 100 to about 600° C. Lower pressures such as a gauge pressure below about 10 MPa favors nitrogen removal, whereas relatively higher pressure, for instance from about 0.5 MPa to about 8 MPa encourages sulfur removal. The metal dispersion, increased after the hot hydrogen stripping of the spent catalyst.

### FIELD OF THE INVENTION

The present invention is related to methods useful to remove nitrogen contamination from catalysts. It relates more particularly to methods of simultaneously removing nitrogen and sulfur contamination from catalysts.

### BACKGROUND OF THE INVENTION

In chemical processes requiring the use of a catalyst, a major problem is deactivation of the catalyst due to contamination of the active sites with impurities. Contaminants such as coke or so-called “green oil” can accumulate on catalysts in hydrogenation operations, and the contaminants are typically removed in an oxygenation regeneration or “burn off” step where an oxygen-containing gas is passed through the deactivated catalyst at elevated temperature.

In some processes, sulfur can be a contaminant of the catalyst, and in such cases it is known to remove the sulfur by stripping the catalyst with a gas stream containing hydrogen at elevated temperatures. Hydrogen stripping can involve feeding a mixture of 5-10% hydrogen and the balance nitrogen to the spent catalyst at 350° C. and 50 psig (0.3 MPa). This is generally less time-consuming than oxygenation.

However, it is also possible for catalysts to be contaminated with nitrogen, and nitrogen containing compounds such as amines. It would thus be desirable if methods could be devised or discovered to remove nitrogen contamination from catalysts in such a way that would make them useful again.

### SUMMARY OF THE INVENTION

There is provided, in one non-limiting embodiment, a method for removing nitrogen contamination from a catalyst that involves contacting the contaminated catalyst with a stream comprising hydrogen at a temperature between about 200 to about 1,000° F. (about 93 to about 538° C.) for a period of time effective to remove at least some of the nitrogen contamination.

In another embodiment, there is provided a method for removing both nitrogen and sulfur contamination from a catalyst that involves contacting the contaminated catalyst with hydrogen at a temperature between about 200 to about 1,000° F. (about 93 to about 538° C.) and at a gauge pressure ranging from about 5 to about 80 atm (about 0.5 MPa to about 8.1 MPa) for a period of time effective to remove at least some of the nitrogen and sulfur contamination.

### BRIEF DESCRIPTION OF THE DRAWINGS

FIG. 1 is a graph of the results of hydrogen stripping of the Example 1 catalyst at 270 psi (1.86 MPa) as a function of time (no H₂S detected);

FIG. 2 is a graph of the results of hydrogen stripping of the Example 2 catalyst at 600 psi (4.12 MPa) and at ambient pressure as a function of time (no H₂S detected);

FIG. 3 is a graph of the results of hydrogen stripping of the Example 3 catalyst at 270 psi (1.86 MPa) as a function of time (no H₂S detected);

FIG. 4 is a graph of the results of hydrogen stripping of the Example 4 catalyst at 600 psi (4.12 MPa) and at ambient pressure as a function of time (no H₂S detected); and

FIG. 5 is a graph of NH₃-TPD of various isomerization catalysts as a function of temperature.

### DETAILED DESCRIPTION OF THE INVENTION

A method has been discovered for removing nitrogen and sulfur contamination from catalysts, particularly spent or used catalysts by stripping them with a gas containing hydrogen at elevated temperatures. Furthermore, it was discovered that relatively low pressures favor nitrogen removal and relatively high pressures favor sulfur removal. In some cases, sulfur removal was impaired to some extent after the coke-burning regeneration.

Nitrogen or sulfur contamination has occurred several times to the catalyst in an isomerization unit (for C5/C6 isomerization) in a particular refinery. The catalyst is a Pt/Mordenite catalyst with a rated lifetime of 5 years. A load of the catalyst was regenerated after 3 years of service due to nitrogen and sulfur contaminations. Although 99% nitrogen was removed during the coke-burning (oxidation) regeneration, sulfur remained with the catalyst.

If sulfur is not removed, it is converted into sulfate (Pt(SO₄)₂) during the air burning type regeneration, and it can no longer be removed with the hot hydrogen stripping procedure. The theory is that the sulfur compounds attack platinum atoms to form sulfide (PtS₂). The sulfide can be reversibly converted into hydrogen sulfide under hydrogen pressure and high temperature. Then the H₂S is stripped out with the hydrogen flow.

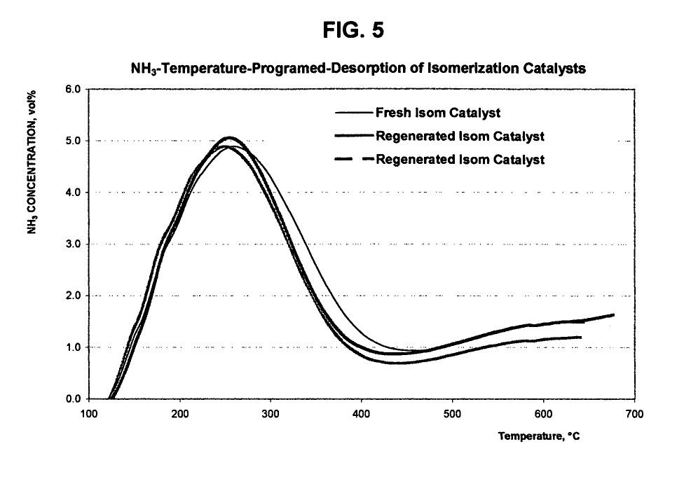

The analysis of the spent catalysts indicated the coke content was minimum. In addition, NH₃-TPD (temperature programmed desorption) analysis indicated that no permanent loss of the intrinsic acid sites, as shown in FIG. 5. The NH₃-TPD analysis indicated that the ammonia desorption completed at about 400° C. Without wishing to be bound by any particular theory, one hypothesis is that the regular burning type regeneration removes the nitrogen simply by desorption at elevated temperature. The temperature in a hot hydrogen stripping should remove nitrogen, as well as remove some of the sulfur contamination.

In more detail, one non-restrictive embodiment of the method involves removing nitrogen contamination from a catalyst by stripping with a hydrogen-containing stream at elevated temperatures for a sufficient period of time to remove at least some of the nitrogen contamination. In an alternate non-limiting embodiment, the temperature of the hydrogen-containing stream is between about 100 to about 600° C., in an alternate non-limiting embodiment the lower end of the temperature range may be about 700° F.(about 370° C.) while the upper end of the range may be 950° F.(about 510° C.).

The stripping stream may be predominantly (>50%) hydrogen. Other components sufficiently inert to the stripping process may include, but are not necessarily limited to, nitrogen, helium, argon, steam. In an alternative non-limiting embodiment, the stripping stream is substantially all hydrogen. By “substantially all” hydrogen is meant at least 95% hydrogen where the balance is impurities. The stripping stream should not contain any components that would substantially interfere with the nitrogen decontamination.

With respect to pressure conditions, in one non-limiting embodiment, the contacting occurs at a gauge pressure ranging 0 to about 10 MPa, alternatively from about 0 to about 68 atm (about 6.9 MPa). In another non-limiting embodiment, the stripping may occur at a gauge pressure ranging from about 0 to about 40 atm (about 4.0 MPa).

It was discovered that the removal of sulfur contamination proceeds better at somewhat higher pressures, for instance between about 5 and about 80 atm (about 0.5 to about 8 MPa). In another non-restrictive embodiment, the stripping for sulfur removal may occur at a gauge pressure having a lower threshold of about 10 atm (about 1.0 MPa) and/or an upper threshold of about 40 atm (about 4.0 MPa). In an alternate non-limiting embodiment, the gauge pressure may range from about 5 atm to about 40 atm (about 0.5 to about 4.0 MPa).

The period of time over which the hot hydrogen stripping occurs is not particularly critical, and may be at least 10 minutes, and in another non-limiting embodiment be at least 1 hour, and alternatively at least 2 hours. While there is no particular maximum stripping time, at some point diminishing returns are reached. In an alternate non-limiting embodiment, the maximum stripping time may be about 100 hours, and alternatively, about 3 hours.

The process is not limited to any particular type of catalyst. Suitable catalysts to be treated in the method include, but are not necessarily limited to, isomerization catalysts, hydrogenation or dehydrogenation catalysts, condensation catalyst, Ziegler-Natta catalysts, hydration/dehydration catalysts, Friedel-Crafts catalysts, alkylation catalysts, oxidation catalysts, polymerization catalysts, cracking catalysts, and the like. Furthermore, the method is not limited to any particular metal or promoter or catalyst substrate or support. Non-limiting examples of more specific suitable catalysts to be treated by the method include, but are not necessarily limited to, platinum-on-mordenite, metal acid dual function catalysts. As noted, both spent and regenerated catalyst may be treated by this method advantageously.

In one non-limiting embodiment, the nitrogen content is reduced to at least by about 50%; alternatively to by at least about 95%. If sulfur is also removed, at least about 5% of the sulfur contamination is removed, alternatively at least 10% sulfur contamination is removed, and in another non-restrictive embodiment at least 15% is removed.

There is nothing critical about the manner of stripping or contacting the catalyst with the stripping gas. Any of the commonly used stripping techniques and equipment may be used, including techniques and equipment yet to be devised, developed or invented, as long as sufficiently intimate contact to achieve the goals of the method is used. Such manner or methods include, but are not necessarily limited to fluidized bed, fixed bed, rotary kiln and other restoration, renewal, reactivation methods, and combinations thereof.

The method will now be discussed with respect to certain specific Examples which are not intended to limit the method in any way, but rather to more fully illustrate certain non-limiting embodiments thereof.

Catalyst Samples:

A spent catalyst was sampled from a commercial unit that suffers from sulfur and nitrogen contamination, identified as Catalyst A. The catalyst after coke-burning type of commercial regeneration is identified as Catalyst B.

### EXAMPLE 1

30 ml of catalyst A was loaded to a reactor. After the reactor was flushed with nitrogen the system pressure was increased to 1.96 MPa and hydrogen rate was kept at 500 sccm (standard cubic centimeters/minute). The temperature was then ramped at 50° C./h to 200° C. and held overnight. The following morning, the temperature was ramped at the same rate to 500° C. and held for eighteen hours. Starting from 300° C., the gas effluent was analyzed by H₂S— and NH₃— Draeger tubes hourly. The catalyst bed temperature was cooled to ambient under hydrogen flow. The unloaded catalyst sample was collected for sulfur and nitrogen analysis, as well as platinum dispersion and NH₃-TPD.

### EXAMPLE 2

Example 1 was repeated, except with Catalyst B. The effluent NH₃ was expected low since the nitrogen had been removed during the regeneration before the test.

### EXAMPLE 3

Example 1 was repeated except for using 4.24 MPa then at ambient pressures.

### EXAMPLE 4

Example 2 was repeated except for using 4.24 MPa then at ambient pressures.

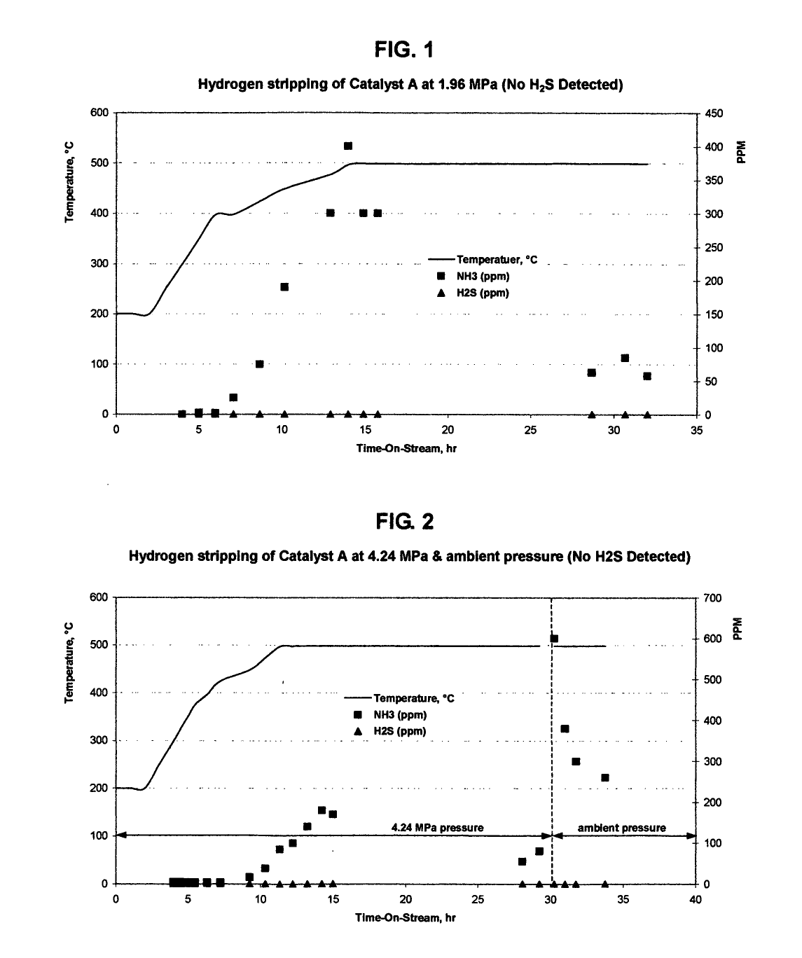

The catalyst A was tested at 1.96 MPa hydrogen and 200-500° C. As seen in FIG. 1, ammonia was detected in the effluent stream at 388° C., and reached 300 ppm at 500° C. After running overnight at this temperature, the ammonia concentration decreased to 50-100 ppm. However, no hydrogen sulfide was detected. Since the catalyst had a much higher nitrogen contamination than sulfur, the ammonia in the effluent stream could interfere with detection of hydrogen sulfide by forming ammonia sulfide. The regenerated sample, in which nitrogen was already removed, was tested for the sulfur and nitrogen removal at the same conditions.

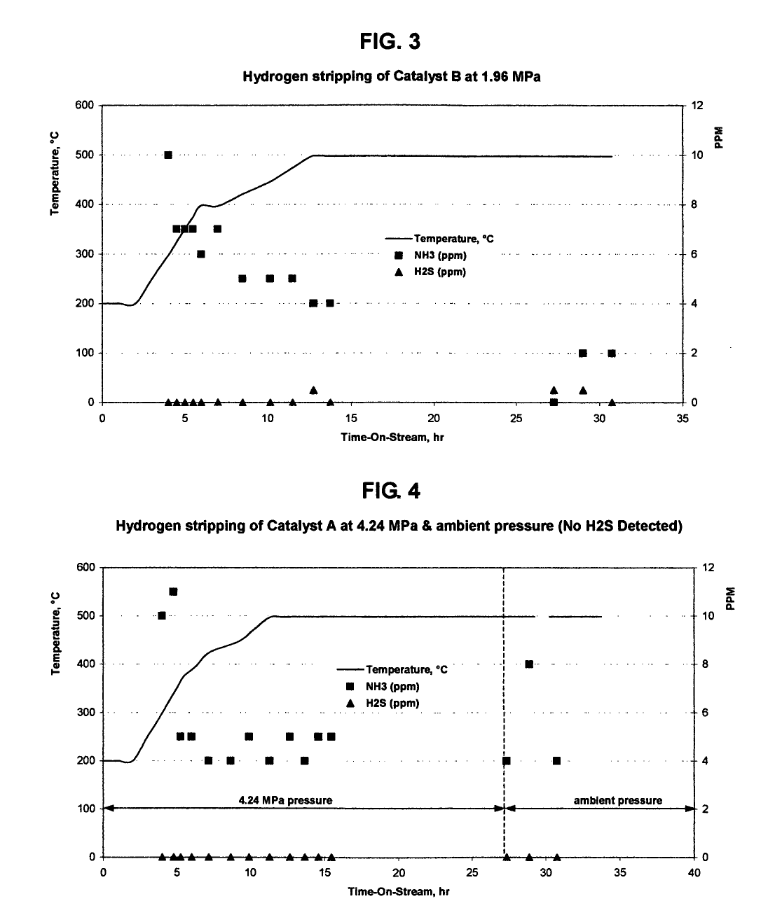

FIG. 3 shows the testing results on the Example 3 sample. The catalyst had only 14 ppm nitrogen. During the hydrogen stripping, 2-10 ppm ammonia was detected in the effluent stream. With this low NH₃ concentration, trace H₂S was detected at 0.5 ppm after stripping at 500° C.

The following two runs tested a higher pressure, 4.24 MPa, to check if the H₂S removal could be promoted. FIG. 2 showed the suppression of nitrogen removal in the catalyst A. Ammonia was 170 ppm comparing to 300 ppm at 1.96 MPa. No H₂S was detected likely due to NH₃ interference. After running overnight, the pressure was reduced to ambient (30 hr); ammonia peaked at 600 ppm then decreased rapidly to 260 ppm at 34 hr.

A similar test at 4.24 MPa was applied to the Catalyst B. The stripping showed much lower ammonia, around 5 ppm in the hydrogen effluent stream, even at ambient pressure and 930° F. (499° C.). There were 14 ppm nitrogen and 133 ppm sulfur based on solid catalyst weight before the H₂ stripping. Again, no H₂S was detected. These results are shown in FIG. 4.

The catalyst samples after stripping were collected for analysis. It is known that sulfur poisons platinum activity, hence appearing at a lower Pt dispersion. Table I shows that the spent catalyst has a higher tendency for sulfur removal, while the regenerated sample went almost unchanged. Sulfur is hard to remove when the platinum sulfide is converted into platinum sulfate during coke burning regeneration.

TABLE I
Pt Dispersion of the Isomerization Catalysts
After Hydrogen Stripping at 500° C.

| Sample | No stripping | 1.96 MPa | 4.24 MPa* |
|---|---|---|---|
| Cat. A | 10.5% | 29.9% | 22.2% |
| Cat. B | 20.5% | 19.6% | 18.2% |

*Performed at 4.24 MPa then at ambient pressure.

The catalyst samples were analyzed for sulfur and nitrogen. Table II shows that almost all of the nitrogen was removed from the spent samples and that some sulfur was removed from the spent and regenerated samples.

TABLE II
Isomerization Catalysts After Hydrogen Stripping
at 930° F. (499° C.)

| | N, ppm | | | S, ppm | | |
|---|---|---|---|---|---|---|
| | No | 1.96 | 4.24 | No | 1.96 | 4.24 |
| Sample | stripping | MPa | MPa* | stripping | MPa | MPa* |
| Cat. A | 1871 | Ex. 1 | Ex. 2 | 125 | Ex. 1 | Ex. 2 |
| | | 38 | 25 | | 82 | 74 |
| Cat. B | 14 | Ex. 3 | Ex. 4 | 133 | Ex. 3 | Ex. 4 |
| | | <1 | <1 | | 105 | 87 |

*Performed at 4.24 MPa then at ambient pressure.

In summary, the hot hydrogen stripping tests of the method for the removal of nitrogen contamination was successful. Over 95% nitrogen was removed from the spent catalyst samples after the 30-hour treatment. The 14-ppm residue nitrogen from regenerated catalyst was removed to below 1 ppm. Low pressure was found to favor nitrogen removal.

Sulfur was demonstrated to be stripped off the catalyst, though not completely. Sulfur was more difficult to remove than nitrogen, and even harder after the catalyst air-burning regeneration. About 34-40% sulfur was removed from the spent catalyst, and 20-34% for the regenerated catalyst. Higher hydrogen pressure favors sulfur removal.

The Pt activity, measured by Pt dispersion, increased after the hot hydrogen stripping for the spent catalyst. However, the Pt dispersion was unchanged for the regenerated catalyst.

In the foregoing specification, the method has been described with reference to specific embodiments thereof, and has been demonstrated as effective in providing methods for removing nitrogen, and optionally also sulfur, contamination. However, it will be evident that various modifications and changes can be made thereto without departing from the scope of the method as set forth in the appended claims. Accordingly, the specification is to be regarded in an illustrative rather than a restrictive sense. For example, specific catalysts, hydrogen-containing streams and stripping conditions, and other factors falling within the claimed parameters, but not specifically identified or tried in a particular contamination removal system, are anticipated and expected to be within the scope of this method. Further, the methods are expected to work at other conditions than those exemplified herein, particularly temperature and pressure conditions.

We claim:

1. A method for removing nitrogen contamination from a catalyst comprising contacting the contaminated catalyst with a stream comprising hydrogen at a temperature between about 100 to about 600° C. for a period of time effective to remove at least some nitrogen contamination.

2. The method of claim 1 where the contacting occurs at a gauge pressure ranging from about 0 to about 10 MPa.

3. The method of claim 1 where the contaminated catalyst is selected from the group consisting of spent catalysts and regenerated catalysts.

4. The method of claim 3 where the catalyst is a platinum-on-mordenite catalyst.

5. The method of claim 1 where the period of time is at least 10 minutes.

6. The method of claim 1 where nitrogen contamination is reduced by at least about 50%.

7. The method of claim 1 where the catalyst is also contaminated with sulfur and at least a portion of the sulfur contamination is also removed.

8. The method of claim 7 where the contacting occurs at a gauge pressure ranging from about 0.5 MPa to about 8 MPa.

9. The method of claim 1 where at least about 5% sulfur contamination is removed.

10. The method of claim 1 where the stream is at least 50% hydrogen.

11. A method for removing nitrogen and sulfur contamination from a catalyst comprising contacting the contaminated catalyst with a stream comprising hydrogen at a temperature between about 100 to about 600° C. and at a gauge pressure ranging from about 0.5 MPa to about 8 MPa for a period of time effective to remove at least some nitrogen and some sulfur contamination.

12. The method of claim 11 where the contaminated catalyst is selected from the group consisting of spent catalysts and regenerated catalysts.

13. The method of claim 12 where the catalyst is a platinum-on-mordenite catalyst.

14. The method of claim 11 where the period of time is at least 10 minutes.

15. The method of claim 11 where nitrogen contamination is reduced by at least about 50%.

16. The method of claim 11 where at least about 5% sulfur contamination is removed.

17. A method for removing nitrogen and sulfur contamination from a catalyst selected from the group consisting of spent catalysts and regenerated catalysts, the method comprising contacting the contaminated catalyst with a stream comprising hydrogen at a temperature between about 100 to about 600° C. and at a gauge pressure ranging from about 0.5 MPa to about 8 MPa for at least 10 minutes to remove at least some nitrogen and some sulfur contamination.

18. The method of claim 17 where the catalyst is a platinum-on-mordenite catalyst.

19. The method of claim 17 where nitrogen contamination is reduced by at least about 50%.

20. The method of claim 17 where at least about 5% sulfur contamination is removed.
